(19) United States
(12) Patent Application Publication
(10) Pub. No.: US 2025/0205659 A1
(43) Pub. Date: Jun. 26, 2025

(54) Modular Paddle with Replaceable Wear Resistant Element

(71) Applicant: Kennametal Inc., Latrobe, PA (US)

(72) Inventors: Ruy Frota De Souza Filho, Latrobe, PA (US); Pavel Ledyan, Bentonville, AR (US); Thomas Long, Greensburg, PA (US); Brandon Kenno, Windber, PA (US); Alan Bookheimer, Greensburg, PA (US)

(73) Assignee: Kennametal Inc., Latrobe, PA (US)

(21) Appl. No.: 18/390,027

(22) Filed: Dec. 20, 2023

(51) Int. Cl. B01F 27/052; B01F 27/1125

(52) U.S. Cl. CPC B01F 27/052; B01F 27/1125

(57) ABSTRACT

An impeller assembly comprises a main body adapted to be operatively coupled to a material processing machine, a tip removably attached to the main body, and a fastening assembly. The fastening assembly includes a first mounting element moveably arranged within one of the main body or the tip along a first axis, a second mounting element fixed to the other one of the main body or the tip, and a fastener. The fastener is adapted to bias the first mounting element along the first axis between a first position in which the second mounting element is slidably engageable with the first mounting element, and a second position wherein the tip is fixedly secured to the main body.

### FIELD OF THE INVENTION

The present disclosure relates to material processing devices, and more specifically, to a material processing element, such as an impeller, hammer, blade or paddle having at least one removeable element.

### BACKGROUND

Mixing, blending, comminution, and classification operations, by way of example, are common in material processing and manufacturing across a wide variety of industries and applications. These processes may be performed by hand or by machine, and may utilize various modes of agitation to blend material (e.g., rotation, vibration, etc.) As an example, mixing machines often implement rotating or otherwise moving elements or impellers, such as paddles or blades, to merge materials together. Due to the often harsh mechanical properties of the material(s) being processed or mixed, as well as operational parameters (e.g., mixing time, speed, etc.), wear on these elements may be substantial. As a result, the elements must be replaced with significant frequency. In addition to being costly, the routine replacement of these elements can be time consuming, and thus limiting to overall processing output and efficiency.

Additionally, wear on the elements may not be uniform, as frictional forces acting thereon tend to be highest on the leading edges and distal ends thereof. Thus, replacing an entire element may be unnecessarily wasteful. Likewise, the mechanical requirements for certain features or areas of the mixing element may be distinct from others. In this way, a monolithic element, as found in the prior art, may not be optimal. For example, for strength and corrosion resistance in a primary body and mounting area of the element (e.g., where the element is attached to a rotating spindle of a machine), a material such as stainless steel may be preferred. In distinction, it may be desired to form a tip, end and/or leading edge of the element from a harder and/or more wear resistant material, such as cemented tungsten carbide.

Accordingly, improved elements addressing the above drawbacks are desired.

### SUMMARY

According to an embodiment of the present disclosure, an element, such as an impeller or an impeller assembly, comprises a body adapted to be operatively coupled to a material processing machine (e.g., a mixing machine), a tip removably attached to the body, and a fastening assembly. The fastening assembly includes a first mounting element moveably arranged within one of the body or the tip along a first axis, a second mounting element fixed to the other one of the body or the tip, and a fastener. The fastener is adapted to bias the first mounting element along the first axis between a first position in which the second mounting element is slidably engageable with the first mounting element, and a second position wherein the tip is fixedly secured to the body.

### BRIEF DESCRIPTION OF THE DRAWINGS

The invention will now be described by way of example with reference to the accompanying Figures, of which:

FIG. 1 is a perspective view of an element, impeller, blade, or paddle according to an embodiment of the present disclosure;

FIG. 2 is a partial perspective view of the element of FIG. 1 illustrating a main body, a removeable and/or replaceable tip thereof, and fastening assembly;

FIG. 3 is a perspective view of the main body of the element of the preceding figures with the tip and fastening assembly removed therefrom;

FIG. 4 is a perspective view of the main body of the element of the preceding figures with the tip removed therefrom;

FIG. 5 is a perspective view of the tip of the element of the preceding figures;

FIG. 6 is a perspective view of at least a portion of the fastening assembly according to an embodiment of the present disclosure;

FIG. 7 is a partial perspective view of a main body of an element according to another embodiment of the present disclosure;

FIG. 8 is a partial perspective view of an element according to another embodiment of the present disclosure;

FIG. 9 is a partial perspective view of a main body and fastening assembly of an element according to another embodiment of the present disclosure;

FIG. 10 is perspective view of a tip adapted for use with the main body of the embodiment of FIG. 9;

FIG. 11 is a partial perspective view of the element including the main body and tip of FIGS. 9 and 10 secured together via the fastening assembly;

FIG. 12 is a partial perspective view of a main body and fastening assembly of an element according to another embodiment of the present disclosure;

FIG. 13 is perspective view of a tip adapted for use with the main body of the embodiment of FIG. 12;

FIG. 14 is a partial perspective view of the element including the main body and tip of FIGS. 12 and 13 secured together via the fastening assembly;

FIG. 15 is perspective view of a tip of an element according to another embodiment of the present disclosure; and

FIG. 16 is a partial perspective view of the element including the main body and tip of FIGS. 12 and 15 secured together via the fastening assembly.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Embodiments of the present disclosure include a rotating element, impeller, paddle, or blade adapted to be mounted to a machine (e.g., to a rotating output thereof). The element includes a main body formed from a first material, such as stainless steel, and at least one replaceable end or tip removably attached thereto. The replaceable end may be formed from a second material, distinct from the first material, such as cemented tungsten carbide. The end defines at a least a portion of a leading edge or working surface of the element adapted to be in contact with the material(s) during operation (e.g., mixing, dispersing, milling, etc.) In one exemplary embodiment, the end is secured to the main body via a fastening or fastener assembly. The fastening assembly includes a first mounting element embodied as a rail element slidable mounted within the main body, and a connecting member or fastener attached to the rail element. The replaceable end includes a second mounting element or boss adapted to be slidably engaged with the rail element. With the replaceable end attached to the main body, the fastening assembly is adapted to selectively bias the rail element toward and/or into the main body, drawing the end into contact with the main body and securing it thereto.

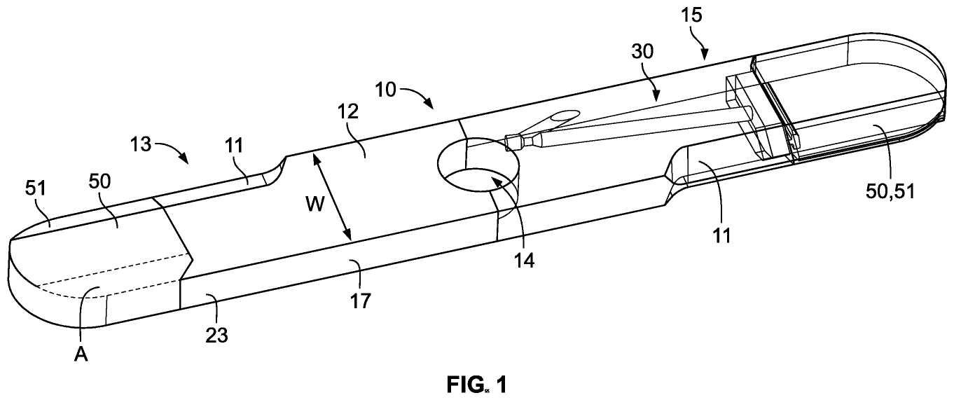

Referring generally to FIG. 1, a simplified exemplary element, impeller paddle, or blade 10 is shown. In the exemplary illustration, a first side or end 13 of the element 10 illustrates only its exterior form, whereas as a second side or end 15 of the element is shown in shadow, illustrating its internal construction and components, including a fastening assembly 30. The element or element assembly 10 includes a main body 12 and a pair of removable and/or replaceable blade ends or tips 50. Each replaceable end 50 is selectively retained by a respective one of the fastening assemblies 30 (with one being shown). The element 10 is described as having the two sides 13, 15 arranged opposite one another relative to a center of the element in a longitudinal direction.

It should be understood that, but for their distinct orientation about a longitudinal axis, the longitudinal ends or sides 13, 15 of the element 10 may be identical to one another. Thus, the relevant descriptions herein will apply equally to either side 13, 15. While the exemplary embodiment includes two replaceable ends 50, it should be understood that the number of replaceable ends may be varied (e.g., 1, 3, etc.) without departing from the scope of the present disclosure. Further, while the exemplary ends 50 are each removeable, in other embodiments, one or more ends or tips may be irremovably fixed to the main body 12 (e.g., formed integrally therewith).

The main body 12 defines a centrally located, generally circular opening 14 adapted to receive, for example, a drive spindle of a material processing machine. One or more keyways or splines may be defined within the opening 14 for engaging with corresponding drive keys or keyways of the spindle of the machine for driving the element 10 in a rotational manner. The main body 12 further includes tapered faces 11 defining portions of leading edges or working surfaces of the element 10. Likewise, the replaceable ends 50 may each include tapered faces 51 defining a remaining portion of a respective one of the leading edges of the element 10. Specifically, the tapered faces 51, 11 of each end 50 and the main body 12 define a continuous, uniform leading edge of the element 10 with the ends attached to the main body. In this way, the element 10 may be directional in nature (i.e., adapted to spin in a one direction during operation). In other embodiments, the tapered leading edges of the element 10 may be formed on each lateral side thereof. In this embodiment, the element 10 may be used to process material in both rotational directions without the need to reorient the element relative to the machine.

As illustrated, the tapered faces 11 are formed only on each distal end of the exemplary main body 12. In other embodiments, the tapered faces 11 may extend over the entire length of each side 13, 15 of the element 10 (i.e., one-half of a total length of the element). In still other embodiments, no portion of the leading edges of the element 10 may be defined by the main body 12, rather, they may be defined only by the ends 50. As shown in FIG. 1, the lateral sides of the element 10 opposite the leading edges in a width direction W may comprise trailing sides or edges 17 which may be oriented generally vertically between top and bottom surfaces of the main body 12 and/or the ends 50, and which do not define a taper.

Still referring to FIG. 1, in some embodiments, a width of the main body 12 and the ends 50 in the width direction W may be generally constant over the length of the element 10. In still other embodiments, the width of the element 10 may taper along its length in each outward radial direction from the center or opening 14. The same may be true for a thickness of the element 10 (i.e., it may be constant, tapered, or otherwise varying). Further, in the exemplary illustrated embodiment, each end 50 defines the entire tip or free end of the element 10 in the width direction W. In other embodiments, however, each end 50 may form only a portion of the distal end of the element 10 in the width direction W. For example, an area A of the free end of the element 10 may be formed integrally with the main body 12, with the removable end 50 defining the remaining portion of the free end. This embodiment may be mechanically advantageous in that forces acting generally normal to and upon the tapered face 51 of the end 50 are directly opposed by the main body 12, relieving stress or strain on the mounting elements by which the end is fixed to the main body.

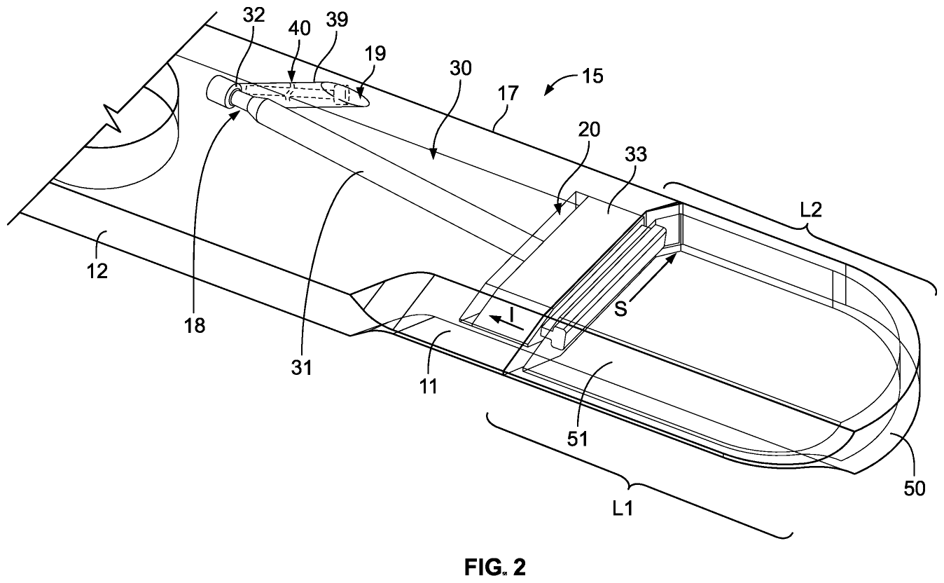

Referring now to FIG. 2, the side 15 of the element 10 is shown along with the exemplary fastening assembly 30 according to a first embodiment of the present disclosure for selective attaching the end 50 to the main body 12. The main body 12 of the element 10 defines a recess 20 formed into a free end thereof at least partially in a radially inward direction with respect to a center of the main body. A first bore or hole 18 is define at least partially into the body 12, and more specifically, extends into the main body from the recess 20. A second bore or hole 19 is formed into the second lateral or trailing side 17 of the main body 12.

According to the first embodiment, the fastening assembly 30 includes a first mounting element or mounting rail 33 slidably received within the recess 20 in a direction I, a connecting rod or element 31 slidably arranged within the first bore 18, and a fastener 39 arranged within the second bore 19. As described in detail herein, the end 50 is fixed to the rail 33 via a complementary “T-slot” type slidable connection. The connecting rod 31 may be formed integrally with the rail 33, or may comprise a separate component fixed thereto (e.g., via a threaded connection 40′, see FIG. 6).

According to the exemplary embodiment, the second bore 19 communicates or opens into the first bore 18 at an oblique angle relative thereto. A free end of the fastener 39 is operative to engage with a recess or surface 32 formed proximate an end of the connecting rod 31 (see also FIG. 6). As the fastener 39 is moved within the second bore 19 (e.g., via a threaded connection 40 between the fastener and the internal wall of the second bore), it is adapted to bias the connecting rod 31 along its longitudinal axis, drawing the rail 33 further into the main body 12 and/or the recess 20 in the direction I. This biases the end 50 into abutting contact with the main body 12, securing it thereto in a releasable or selective manner. In this way, the rail 33 is moveable at least between a first position, wherein the end 50 is slidably engageable with the rail in a sliding direction S, and a second position in which the rail is retracted relative to the main body and the end is fixed to the main body.

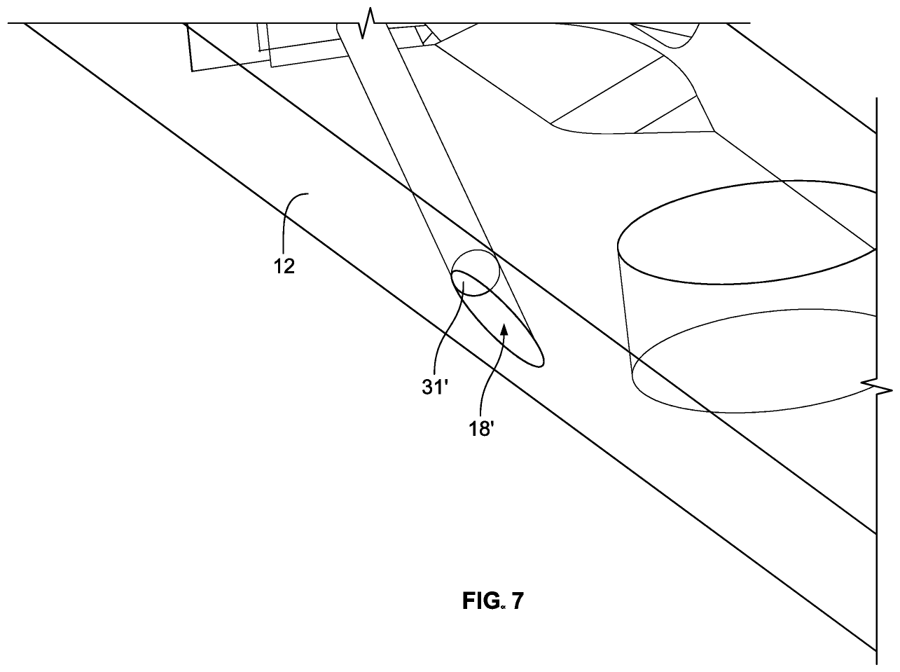

As shown in FIG. 7, according to another embodiment of the present disclosure, the main body 12 comprises a bore or a through hole 18′ which extends from the recess 20 and openings on the second lateral or trailing side 17 of the main body. A fastener or fastening member 31′ is arranged within the through-hole 18′, and is connected to the rail 33, as shown in FIG. 2. In one configuration, the fastener 31′ is threadably connected to the rail 33 and adapted to draw the rail into the recess 20 as the fastener is rotated via the threaded connection, and vice-versa (e.g., via the threaded connection 40′, see FIG. 6). In other embodiments, the fastener 31′ may be threadably connected to the main body 12, and fixedly connected to the rail 33 in an axial direction, but not a radial direction. In this way, rotating the fastener 31′ is also operative to bias the rail 33 within the recess 20 in either direction. It should also be understood that the through-hole 18′ and the fastener 31′ may define a complementary head and shoulder, respectively, such that the depth of insertion of the fastener into the body 12 is limited. In this way, tightening or threading the fastener 31′ into the bore 18′ is operative to draw the rail 33 and the end 50 at least partially radially inward toward the center of the element 10.

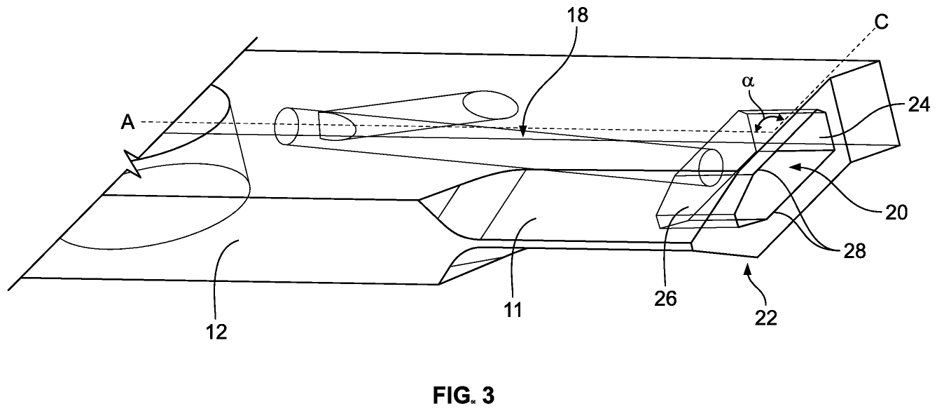

In either embodiment, the bores 18′, 19 are adapted to receive a tool for rotating or otherwise engaging the respective fastener 31′, 39. Each bore 18′, 19 exits or opens on the trailing or second lateral side 17 of the main body 12 opposite the leading edge side. In this way, material(s) being processed by the element 10 is not forcibly introduced into the opening during operation, nor does the element 10 need to be removed from the machine in order to access the fasteners 31′, 39, and thus remove the end(s) 50. This improves reliability, cleanliness, and increases operational efficiency. In either embodiment, these lateral exits or openings are achieved by offsetting a central axis or the bore 18′ or the bore 19 from a central axis of elongation A of the main body 12 (see FIG. 3) by an exemplary non-zero angle (i.e., they are obliquely oriented or non-parallel). Further, as each embodiment provides a threaded connection to bias the rail 33, embodiments of the present disclosure provide a means to adjust the holding force securing the end 50 to the main body 12. This is advantageous in that, depending on the differences in coefficients of thermal expansion between the ends 50 and the main body 12, any loosening of the ends relative to the main body may be addressed via periodic retorquing or tightening of the fasteners 31′, 39.

Referring again to FIG. 2, according to embodiments, the lateral leading edge side of the end 50 may have a length L1 that is equal to a length L2 of the opposite lateral side or trailing side 17. In other embodiments, the lengths of each lateral side L1, L2 may be distinct from one another. For example, the length L2 may be less than the length L1, in this way, the mating end surfaces or faces of the main body 12 and the end 50 may be defined on a plane oriented in a non-tangential manner with respect to the center of the element 10 and its rotational/circular path of operation. This may be mechanically advantageous, as the mating end surfaces of the main body 12 and end 50 at least partially oppose one another in a direction of the normal force acting on the leading edge of the element 10, thus improving support of the end relative to the main body under operational loading. Likewise, the reverse arrangement may be true without departing from the scope of the present disclosure.

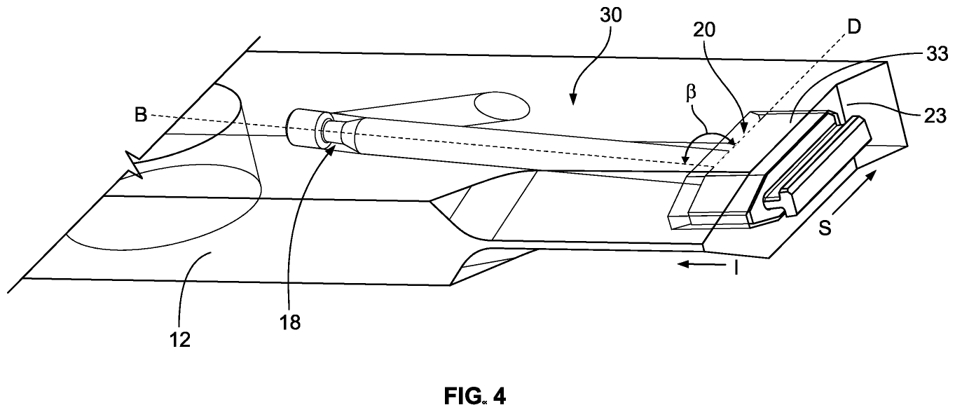

Referring now to FIGS. 3 and 4, the recess 20 of the main body 12 is defined by opposing top and bottom walls 28, a rear wall 24 and a front tapered end 22, and a base wall 26 opposite an open end of the recess. The first bore 18, 18′ opens into the recess 20, and specifically through the base wall 26. The rail 33 may be slidably insertable into the recess 20. In some embodiments, the walls 28 may be tapered to generate a transitioning press fit with the rail 33 as it is drawn into the recess 20 by the fastening assembly 30.

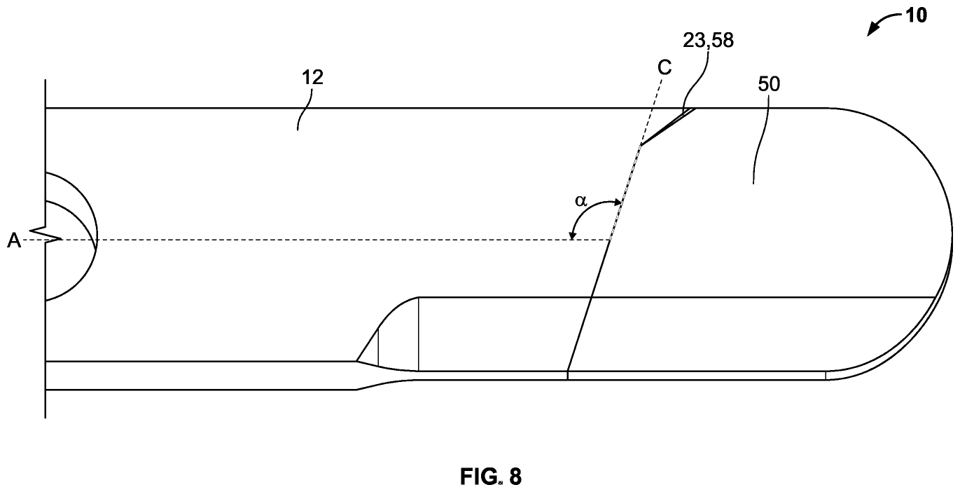

As shown in FIG. 3, in order to advantageously apply a holding force on the end 50, an angle α between an end or mating face of the main body 12 defined along a plane or axis C and the central axis or axis of elongation A of the main body may be approximately ninety degrees. As shown in FIG. 8, in other embodiments, the angle α may be greater than ninety degrees, thus forming the above-described angled mating surfaces of the main body 12 and the end 50 relative to a true tangential direction (i.e., the direction if the angle α is equal to ninety degrees). This arrangement increases the length of the tip or end 50 on the leading edge side which sees the most wear, as well as reduces the overall weight of the end. The resulting reduction in weight of the end 50 is advantageous in that it, for example, decreases stress on associated connecting elements. This is particularly beneficial as operating speeds (i.e., rotational speeds) of the element 10 increase.

Similarly, as shown in FIG. 4, in order to ensure even and/or uniform clamping or compressive force is generated between the end 50 and the main body 12, a central axis of the bore 18 (or through-hole 18′, FIG. 7) and thus of the connecting rod 31 (or the fastener 31′, FIG. 7) may be oriented normally to a plane or axis D defined by the rail 33 (i.e., at an angle β of approximately ninety degrees). In other embodiments, the angle β may be greater than ninety degrees. In this way, the force generated by the rail 33 on the end 50 may be operative to draw a rear face of the rail into compressive or abutting contact with the rear wall 24 of the recess 20, ensuring optimally support of the end against forces acting on the leading edge of the element 10 during operation.

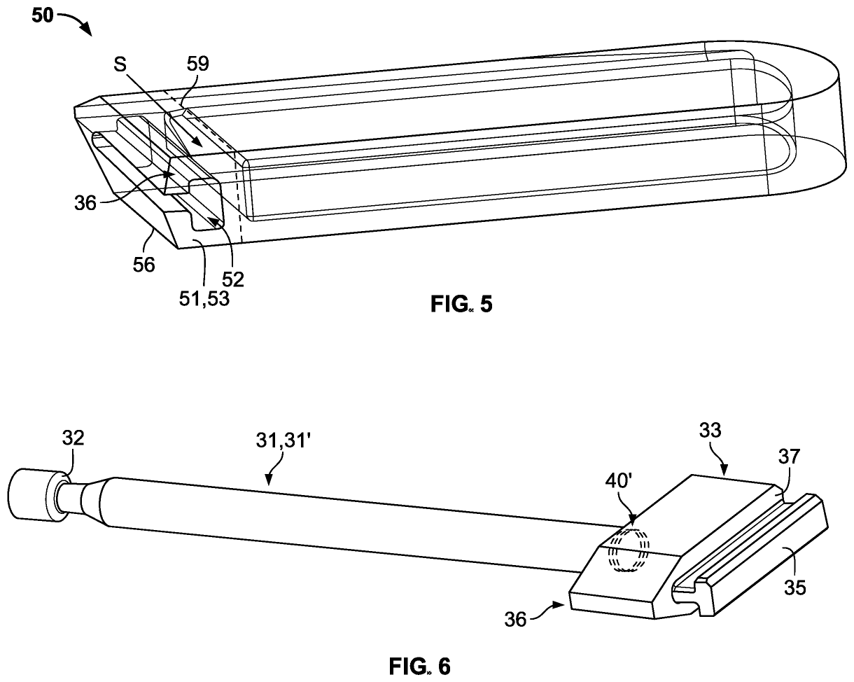

Still referring to FIG. 4, the main body 12 may comprise a tapered mechanical stop 23 extending from an end thereof. The stop 23 protrudes in a manner which intersects a sliding axis of the element 50 on the rail 33, with the sliding axis extending in the illustrated sliding direction S. With reference to FIG. 5, an end wall 53 of the mounting element 51 defines a tapered or inclined surface 58 corresponding to that of the stop 23. Thus, the end 50 will abut the stop 23 as it is slidably mated to the rail 33 in the direction S. As the end 50 and stop 23 at least partially oppose one another in a direction facing the leading edge, in addition to positioning the end, the stop supports the end against normal forces acting on the leading edge thereof during operation.

Referring now to FIGS. 5 and 6, the end 50 includes a mounting element 51 adapted to engage with the rail 33. In the exemplary embodiment, the mounting element 51 defines a T-shaped slot, T-slot, or T-shaped opening 52 adapted to slidably receive a corresponding T-shaped protrusion 35 of the rail 33 in the sliding direction S. The sliding direction S may be normal to the axial direction of the central axis B of the connecting rod 31 or the fastener 31′. A mounting surface or face 56 of the mounting element 51 may be tapered on either side of the opening 52. Likewise, as shown in FIG. 6, either side of a corresponding abutting end surface or face 37 of the rail 33 may also be tapered to match the mounting face 56. The tapered mating faces or surfaces 37, 56 ensure proper alignment or positioning of the element 50 on the rail 33. Further, while the rail 33 may be any suitable shape, in one advantageous embodiment, the rail defines a tapered end 36 extending in a direction of the leading edge(s) of the element 10, and corresponding to the front tapered end 22 of the recess 20.

In any embodiment of the end 50, the mounting element 51 may be formed integrally with a remainder of the end. Likewise, the mounting element 51 may comprise a discrete insert partially embedded within, or affixed to, the end 50. This embodiment is illustrated in FIG. 5 via a part-line 59. More specifically, the end 50 may be formed of a first material, such as cemented tungsten carbide, while the mounting element 51 may be formed from for example, stainless steel. The mounting element 51 may be secured within the remainder of the end 50 via any suitable means, including bonding or brazing. The use of carbide provides the element 10 with superior wear resistance, while the use of steel for the mounting element 51 and/or the main body 12 may offer mechanical strength and fatigue life improvements.

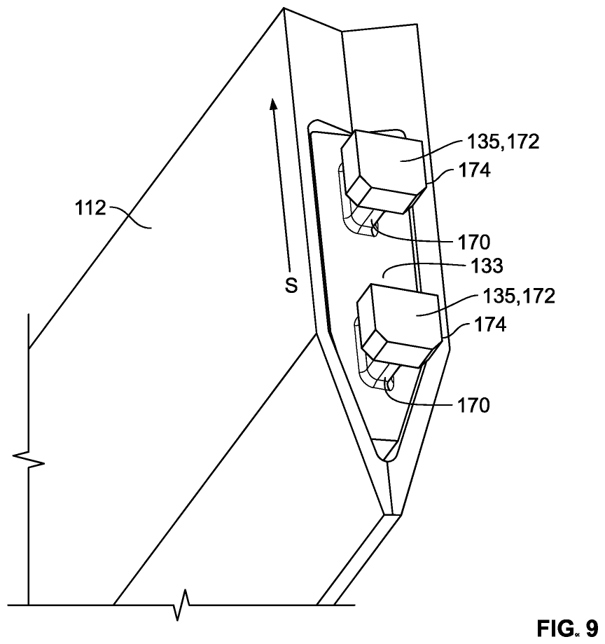

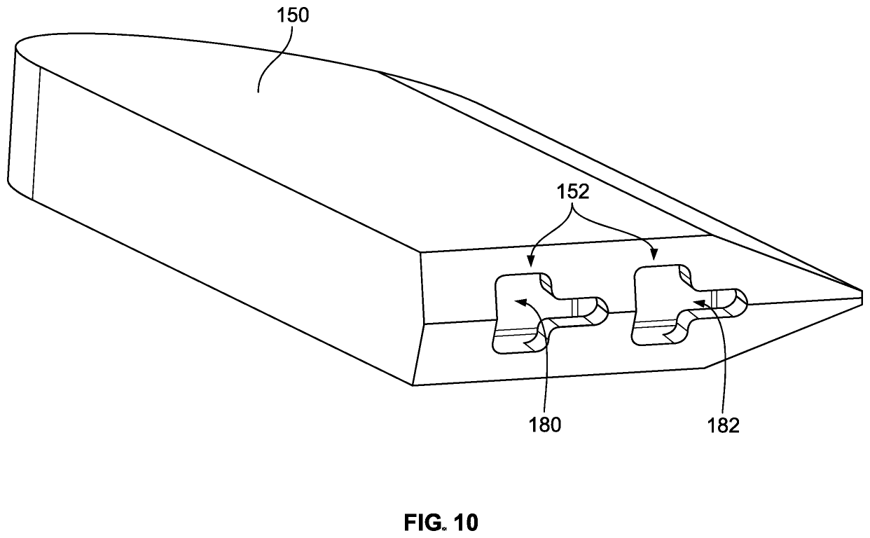

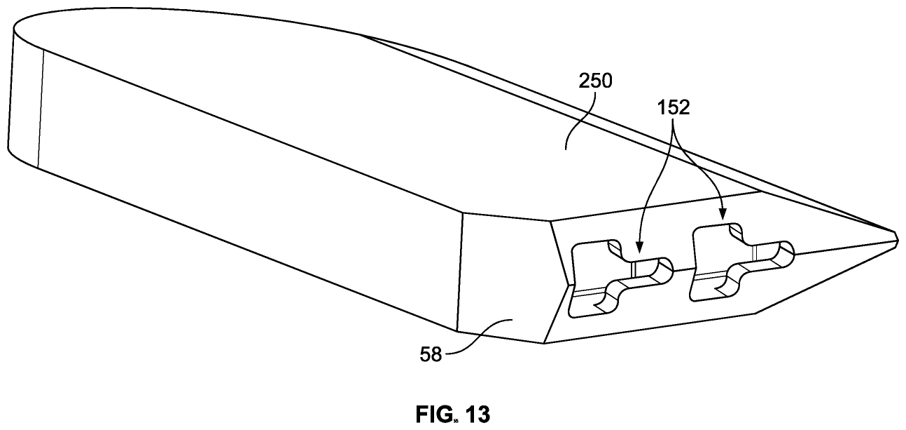

FIGS. 9-16 illustrate variations to the above-described embodiments of the present disclosure. Unless otherwise noted, each of these embodiments comprises features generally similar to those set forth above with respect to FIGS. 1-8. Accordingly, a detailed description of all of the features of these embodiments will not be repeated in the interest of brevity. By way of example, the main bodies and portions of the fastening assembly of these embodiments may be substantially similar to those set forth above.

Referring generally to FIGS. 9-11, an element 110 according to another embodiment of the present disclosure includes a main body 112 and a removable and/or replaceable tip or end 150. In this embodiment, instead of the single T-shaped protrusion 35 of the above-described mounting rail 33, a moveable mounting rail 133 comprises a pair of T-shaped protrusions 135 extending therefrom. Each protrusion 135 includes a stem 170 and an enlarged head portion 172. Leading corners 174 (i.e., corners facing in the sliding direction S) of the head portion 172 may be chamfered or otherwise tapering in the sliding direction.

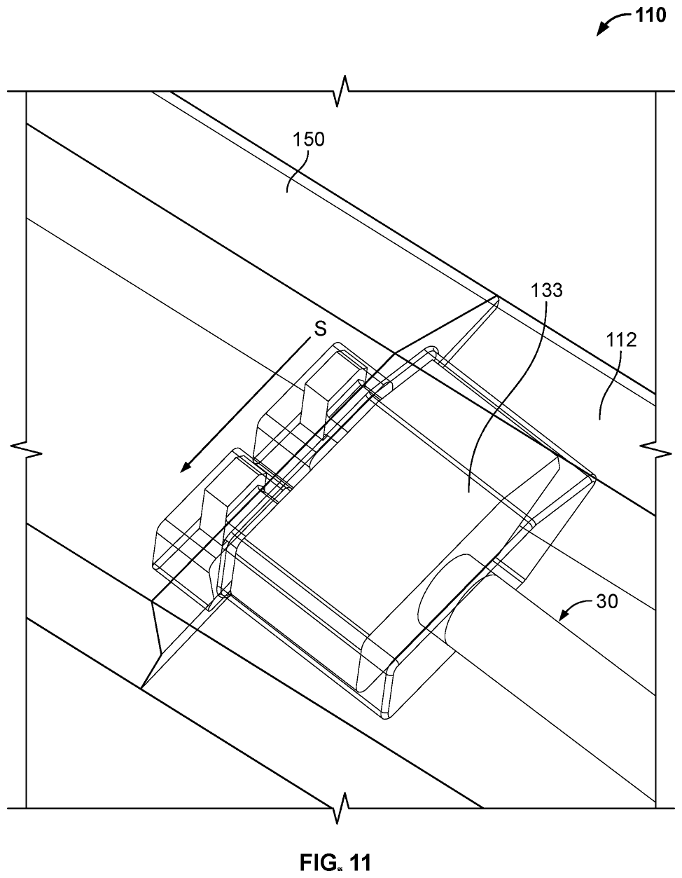

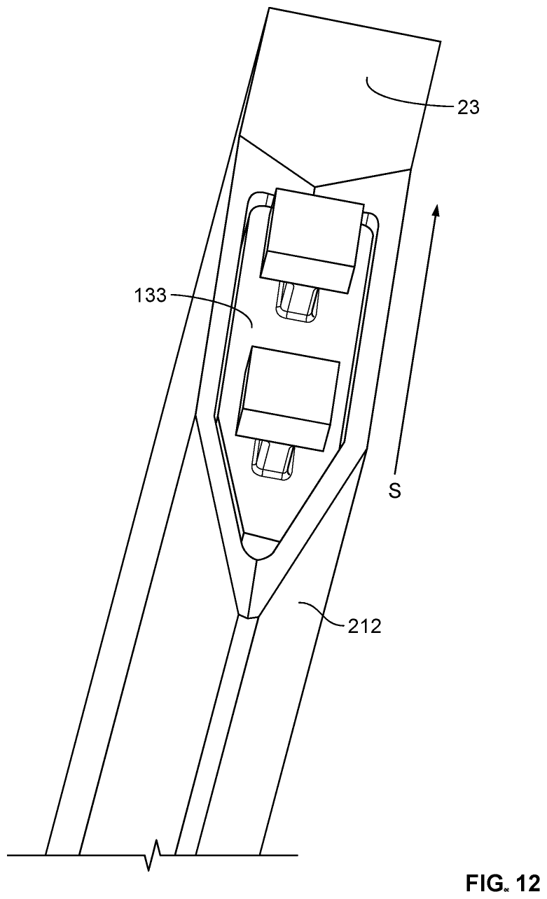

The tip 150 defines a pair of corresponding T-shaped openings 152 (i.e., having a T-shaped cross section) adapted to receive the protrusions 135 therein. Specifically, the openings 152 each include a first aperture 180 sized to receive the head portion 172 of one of the protrusions 135, and a slotted second aperture 182 sized to slidably receive the stem 170 of the protrusion as it is biased in the sliding direction S during installation. The chamfered leading corners 174 and corresponding leading edge of the head portion 172 are adapted to center the protrusions 135 within the openings 152, as well as abut (i.e., form a mechanical stop) with a corresponding opposing interior surface of the opening 152 in the sliding direction S in an installed position of the tip 150, as shown in FIG. 11. In this way, the main body 112 and tip 150 do not require the stop 23 or the opposing surface or recess 58 of the preceding embodiments.

Similarly, and referring to FIGS. 12-15, in another embodiment of the present disclosure an element 210 includes a main body 212 and a tip 250 having features similar to those set forth above with respect to FIGS. 9-11. However, the main body 212 includes the inclined stop or protrusion 23 extending in an axial direction therefrom, and the tip 250 includes the corresponding inclined surface or recess 58 complementary to the stop 23. In this way, as the tip 250 is slidably engaged with the main body 212 in the sliding direction S, engagement of the stop 23 with the corresponding opposing surface 58 of the tip is adapted to set the position of the tip relative to the main body in the sliding direction.

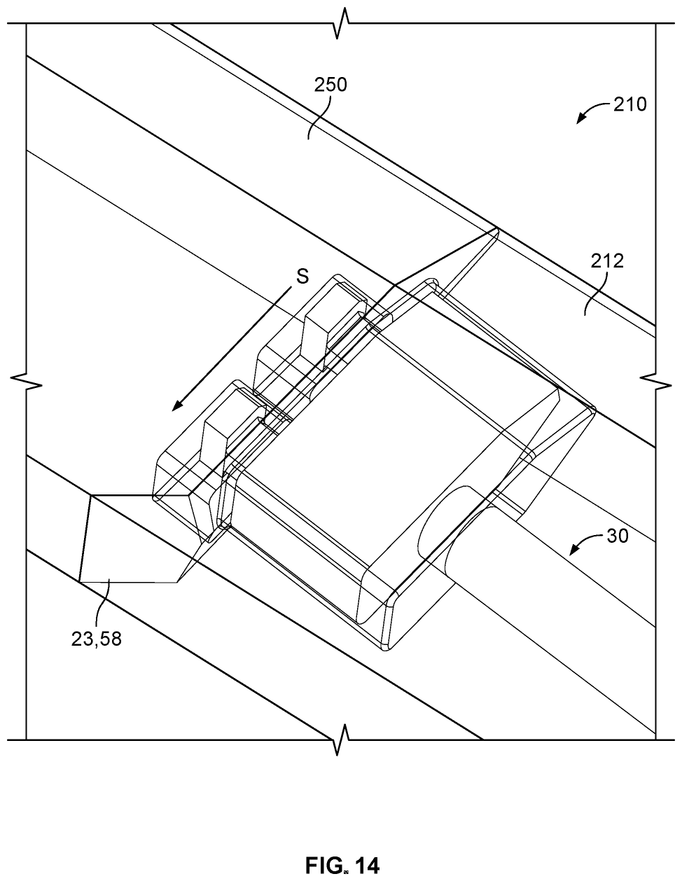

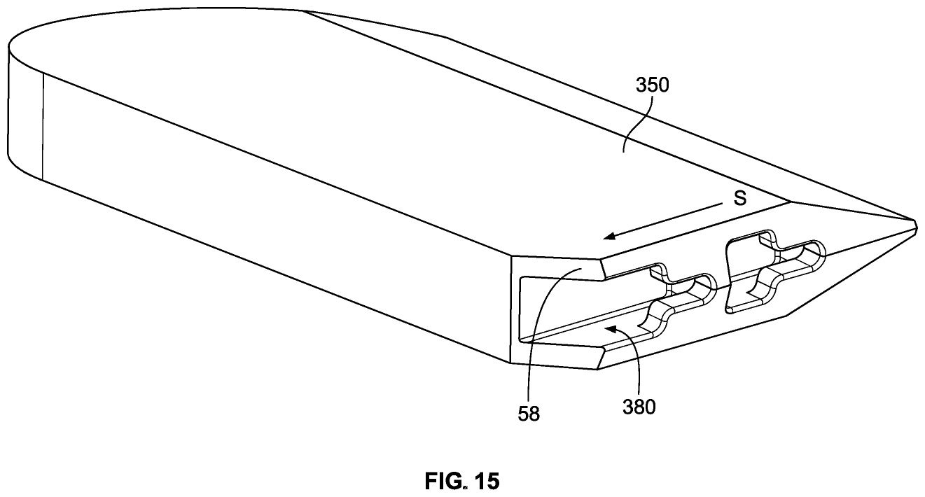

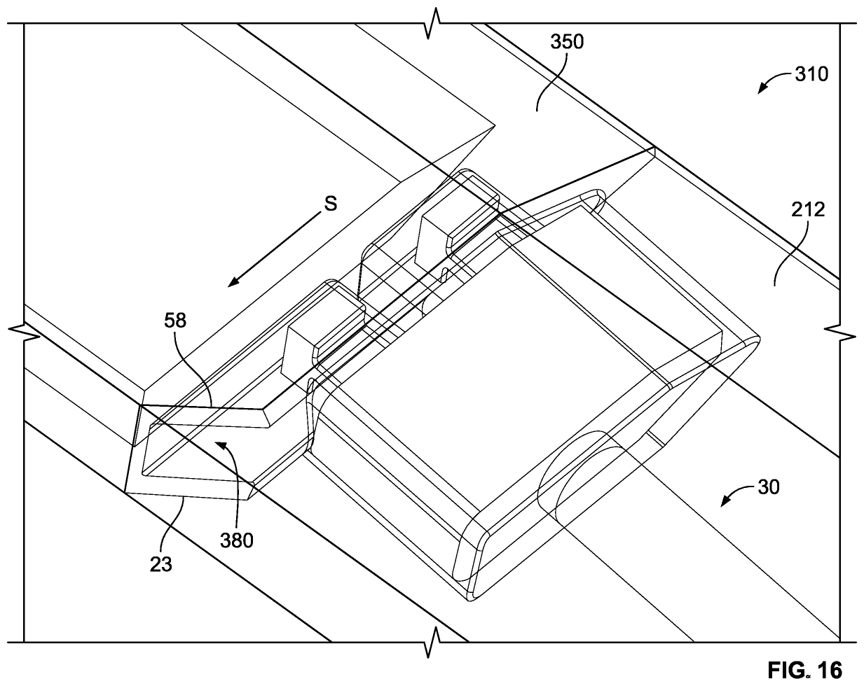

With reference to FIGS. 15 and 16, an element 310 according to another embodiment of the present disclosure includes substantially the same features as the mixing element 210. However, in this embodiment, a tip 350 of the element 310 defines a distinct first aperture 380 adapted to receive one of the protrusions 135. More specifically, the first aperture 380 extends through the opposing surface 58 abutting the stop 23 in the sliding direction S. In addition to reducing an overall weight of the tip 350, this arrangement allows the mounting rail 133 and protrusions 135, as well as the corresponding openings in the tip 350 to be formed more rearwardly, or toward a trailing edge of the element 310 compared to, for example, the embodiments of FIG. 9-14. As illustrated, the tip 350 may be used with the main body 212 shown in FIGS. 12 and 14.

As shown in FIGS. 2, 5 and 16, the wear resistant tip or end according to each embodiment of the present disclosure may be generally hollow in order to reduce centripetal forces acting on, for example, the fastening assembly or interface between the end and the main body. In one embodiment, the volume reduction resulting from this hollow form may range from about 10% to about 50% (i.e., the illustrated cavity inside the end occupies between about 10% to about 50% of an overall volume of the end). More preferably the volume reduction range is about 20% to about 40%. These volume ranges and corresponding weight reductions have been determined to achieve suitable reductions in centripetal forces, while maintaining overall performance and durability requirements of the paddle.

While the exemplary embodiments of the present disclosure are shown and described as having a moveable rail arranged in an end or main body of the element, and a mounting element formed on, or extending from, the removable tip or end, it should be understood that the reverse arrangement may be implemented without departing from the scope of the present invention. As these embodiments include substantially the same features already shown in the drawings, it is respectfully submitted that one of ordinary skill in the art would not require additional figures showing this arrangement in order to have a complete understanding of the disclosure invention.

Further, it should be understood that the overall shape of the elements shown in the figures is only exemplary in nature, and may be varied without departing from the scope of the present disclosure. For example, the distal or free end sides of each of the removable ends or tips may be rounded in nature (as shown), or may be squared-off or linearly angled. Likewise, the replaceable ends or tips may be generally flat or planar relative to the main body (as illustrated), or may be curved at least one of vertically upward or downward (i.e., toward a parallel relationship with a rotational axis of the element. In still other embodiments, the ends may extend obliquely upward and/or downward from the main body.

Elements according to embodiments of the present disclosure are generally adapted for use in material processing operations, including but not limited to, mixing, dispersing, cutting, milling, hammering, and/or agitating processes involving one or more materials (e.g., solid, liquid, and/or semiliquid materials). Likewise, while the elements (e.g., mixing elements) described herein may be generally referred to as impellers, it should be understood that this term includes blades, paddles, hammers, knives or other similar elements or tooling adapted to process (e.g., mix) one or more materials.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. An impeller assembly, comprising:
a body adapted to be operatively coupled to a material processing;
a tip removably attached to the body; and
a fastening assembly, including:
a first mounting element arranged within one of the body or the tip and movable along a first axis;
a second mounting element fixed to the other one of the body or the tip; and
a fastening member adapted to bias the first mounting element along the first axis between:
a first position in which the second mounting element is slidably engageable with the first mounting element; and
a second position wherein the tip is fixedly secured to the body.

2. The impeller assembly of claim 1, wherein the first mounting element and the second mounting element comprise one of a respective at least one protrusion and at least one recess, the at least one recess of the first mounting element or the second mounting element slidably receiving the at least one protrusion of the first mounting element or the second mounting element along a sliding direction.

3. The impeller assembly of claim 2, wherein the at least one protrusion defines at least one generally T-shaped protrusion and the at least one recess defines at least one complementary T-shaped slot adapted to receive the at least one protrusion in the sliding direction.

4. The impeller assembly of claim 3, wherein the at least one protrusion includes a pair of generally T-shaped protrusions and the at least one recess includes a pair of T-shaped slots receiving the pair of T-shaped protrusions.

5. The impeller assembly of claim 2, wherein the body further defines a mechanical stop limiting motion of the second mounting element relative to the first mounting element in the sliding direction.

6. The impeller assembly of claim 2, wherein the sliding direction is oriented generally perpendicular to the first axis.

7. The impeller assembly of claim 1, wherein the body and the tip define:
a first lateral side including a leading edge adapted to impact a material to be mixed; and
a second lateral side opposite the first lateral side.

8. The impeller assembly of claim 7, wherein:
the first mounting element is slidably arranged within a mounting element recess formed into an end of the body; and
the fastening member is threadably engaged with the first mounting element and includes a central axis coincident with the first axis.

9. The impeller assembly of claim 8, wherein the fastening member is arranged in a through-hole extending through the body between the mounting element recess and the second lateral side, the through-hole opening on the second lateral side.

10. The impeller assembly of claim 6, wherein:
the fastening assembly further comprises a connecting element having a first end attached to the first mounting element, a central axis of the connecting element aligned with the first axis;
the first mounting element is slidably arranged within a mounting element recess formed into an end of the body; and
the fastening member is threadably engaged with body and adapted to selectively translate the connecting element along the first axis for biasing the first mounting element between the first position and the second position.

11. The impeller assembly of claim 10, wherein:
the fastening member is arranged within a first bore extending into the body from the second lateral side;
the connecting element is arranged in a second bore extending from the mounting element recess into the body along the first axis; and
the first bore is in communication with the second bore such that the fastening member is selectively engageable with the connecting element.

12. The impeller assembly of claim 11, wherein the first bore is oriented obliquely relative to the second bore.

13. The impeller assembly of claim 1, wherein the tip further includes:
a tip body; and
an insert defining the second mounting element and fixed at least partially within the tip body.

14. The impeller assembly of claim 13, wherein the tip body is formed from a first material, and the insert of the tip is formed of a second material, distinct from the first material.

15. The impeller assembly of claim 14, wherein the tip body includes at least an outer carbide surface.

16. The impeller assembly of claim 1, wherein:
the first axis extends obliquely relative to an axis of elongation of the body; and
the first axis is oriented normally to a plane defined by opposing mating surfaces of the body and the tip.

17. An impeller, comprising:
a body adapted to be operatively coupled to a material processing machine;
a tip removably attached to the body; and
a fastening assembly, including:
a first mounting element moveably arranged within one of the body or the tip;
a second mounting element fixed to the other one of the body or the tip, the fastening assembly adapted to selectively bias the first mounting element between a first position in which the second mounting element is slidably engageable with the first mounting element and a second position wherein the tip is fixedly secured to the body.

18. The impeller of claim 17, wherein the first mounting element is movable within body along a first axis, the first axis is oriented obliquely relative to a central axis of elongation of the body and normally to a plane defined by opposing mating surfaces of the body and first tip.

19. The impeller of claim 17, wherein tip defines a hollow interior cavity having a volume between 10% to 50% of an overall volume of the tip.

20. The impeller of claim 17, wherein the body and the tip define:
a first lateral side including a leading edge adapted to impact a material being processed; and
a second lateral side opposite the first lateral side, wherein a fastening member of the fastening assembly is accessible through the second lateral side and is operative to bias the first mounting element between the first position and the second position.
